(19) United States
(12) Patent Application Publication
(10) Pub. No.: US 2026/0060880 A1
(43) Pub. Date: Mar. 5, 2026

(54) DEVICE FOR RELAXING MUSCLES BY AUTOMATICALLY ROLLING AND PRESSING MUSCLES, CONTROL METHOD AND SLIDING CONTROL METHOD

(71) Applicant: RheoFit Co., Ltd, Shenzhen (CN)

(72) Inventor: Yingdong Sun, Shenzhen (CN)

(21) Appl. No.: 19/382,347

(22) Filed: Nov. 7, 2025

Related U.S. Application Data
(63) Continuation-in-part of application No. PCT/CN2024/087195, filed on Apr. 11, 2024.
(63) Continuation-in-part of application No. PCT/CN2024/093092, filed on May 14, 2024.
(63) Continuation-in-part of application No. PCT/CN2024/093094, filed on May 14, 2024.

(30) Foreign Application Priority Data
May 8, 2023 (CN) 202310509914.X
May 15, 2023 (CN) 202310540374.1
May 15, 2023 (CN) 202310540377.5
Feb. 23, 2024 (CN) 202410201392.1
Feb. 23, 2024 (CN) 202410201394.0

(51) Int. Cl. A61H 15/00

(52) U.S. Cl. CPC A61H 15/0078; A61H 2015/0014; A61H 2201/1215

(57) ABSTRACT

The present invention discloses a device for relaxing muscles by automatically rolling and pressing muscles, a control method and a sliding control method. The device for relaxing muscles comprises an actuating mechanism, a rotating wheel set and a driving mechanism. A first wheel set and a second wheel set are respectively arranged at both ends of the actuating mechanism. The driving mechanism is connected to the first wheel set, the second wheel set and the actuating mechanism, and is used for driving the actuating mechanism to roll automatically. Compared with traditional foam rollers, the present invention provides automated operation, reducing a user's learning effort, physical exertion, and difficulty of use. The present invention enables efficient and deep relaxation of muscles throughout the body, allowing the user to rest or use a mobile phone in a relaxation process. Overall relaxation effect is improved by enhanced muscle relaxation.

### CROSS REFERENCE TO RELATED APPLICATIONS

The present application is a Continuation-In-Part application of PCT Application No. PCT/CN2024/093092 filed on May 14, 2024, which claims the benefit of Chinese Patent Application Nos. 202310540374.1 filed on May 15, 2023 and 202410201392.1 filed on Feb. 23, 2024; is a Continuation-In-Part application of PCT Application No. PCT/CN2024/087195 filed on Apr. 11, 2024, which claims the benefit of Chinese Patent Application No. 202310509914.X filed on May 8, 2023; and is a Continuation-In-Part application of PCT Application No. PCT/CN2024/093094 filed on May 14, 2024, which claims the benefit of Chinese Patent Application Nos. 202310540377.5 filed on May 15, 2023 and 202410201394.0 filed on Feb. 23, 2024. All the above are hereby incorporated by reference in their entirety.

### FIELD OF INVENTION

The present invention relates to the technical field of body-building apparatus, and particularly relates to a device for relaxing muscles by automatically rolling and pressing muscles, a control method and a sliding control method.

### BACKGROUND ART OF THE INVENTION

Existing products for relaxing muscles, such as massage guns and foam rollers, require a manual force during use, which is time-consuming and laborious; whereas products like massage chairs cannot achieve relaxation of front muscles, are huge in size, and cannot achieve relaxation of deep muscles either; various massage devices are also difficult to achieve relaxation of deep muscles, and are time-consuming and laborious when a plurality of parts need to be relaxed.

### DISCLOSURE OF THE INVENTION

In view of this, the purpose of the present invention is to provide a device for relaxing muscles by automatically rolling and pressing muscles. The present invention achieves deep relaxation of most muscles throughout the body in a time-saving and labor-saving manner for a user in both lying and prone positions, and enables the user to take a rest or use a cell phone in a relaxation process. The present invention solves the problem that the user needs to exert a force by his/her own muscles and keep attention to complete the relaxation of most muscles throughout the body.

In one aspect, the present application provides a device for relaxing muscles by automatically rolling and pressing muscles, comprising an actuating mechanism, a rotating wheel set and a driving mechanism; the rotating wheel set comprises a first wheel set and a second wheel set, the first wheel set and the second wheel set are respectively arranged at both ends of the actuating mechanism, the driving mechanism is arranged between the first wheel set and the actuating mechanism, and the driving mechanism is connected to the first wheel set and the actuating mechanism; the driving mechanism is used for driving the actuating mechanism to roll automatically; the driving mechanism comprises a decelerator, a connecting piece and a driving motor.

Optionally, the driving mechanism further comprises a connecting shaft, and the connecting shaft is used for connecting the first wheel set and the second wheel set; and the decelerator is connected to the first wheel set.

Optionally, the actuating mechanism is rotatably sheathed outside the connecting shaft; and a circuit module is arranged in the actuating mechanism.

Optionally, an input end of the decelerator is connected to an output shaft of the driving motor, and an output end of the decelerator is connected to the actuating mechanism.

Optionally, the first wheel set and the second wheel set are either roller wheel sets or track wheel sets.

Optionally, the first wheel set and the second wheel set are concentric wheels.

In another aspect, the present application provides a control method which is applied to the device for relaxing muscles by automatically rolling and pressing muscles in any one of the above items, wherein the control method specifically comprises the following steps:
Acquiring a massage area of a user;
Obtaining a number of rotations that the rotating wheel set should make according to the massage area;
Controlling the driving motor to rotate according to the number of rotations.

Optionally, the step of obtaining a number of rotations that the rotating wheel set should make according to the massage area is specifically as follows:
Acquiring a height and a gender of the user, calculating the massage area for each part of a body based on the height and the gender, or setting the massage area for each part according to a massage need of the user, and converting the massage area into the number of rotations.

Optionally, the driving motor is connected to the rotating wheel set through a planetary gear set, and a number of pulses N corresponding to the number of rotations is:

$$N = ( L / π d ) \cdot z \cdot δ ;$$

where L is a length of the massage area, d is a diameter of a massage part, z is a transmission ratio of a planet carrier to a sun gear in the planetary gear set, and δ is a pulse equivalent of the driving motor.

Optionally, the step of acquiring a massage area of a user is specifically as follows:
Setting the length of the massage area according to the massage need of the user;
Or determining the length L of the massage area according to the height of the user and a proportion coefficient of the massage area to the height of the user, L=H·l, where H is the height of the user, and l is the proportion coefficient of the massage area to the height of the user.

Optionally, the rotating wheel set is provided with position sensors; and the step of controlling the driving motor to rotate according to the number of rotations is specifically as follows:
Starting the driving motor;
Reading an actual number of pulses N′ of the position sensors on the rotating wheel set in real time;
Judging whether the actual number of pulses N′ is equal to a number of pulses corresponding to the number of rotations that the rotating wheel set should make;
If yes, resetting the number of pulses of the position sensors to zero, and controlling the driving motor to rotate reversely, so as to drive the rotating wheel set to move in an opposite direction or stop moving;
If not, controlling the driving motor to continue rotating without changing direction, so as to drive the rotating wheel set to continue moving.

Optionally, the number of pulses corresponding to the number of rotations that the rotating wheel set should make is a number of pulses corresponding to the number of rotations of the rotating wheel set when the device for relaxing muscles moves from a starting position to an ending position of the massage area;

The actual number of pulses N′ is a number of pulses of the position sensors on the rotating wheel set in a massage process of the device for relaxing muscles.

Optionally, the control method further comprises:
Setting a target rotational speed of the device for relaxing muscles;
Collecting a current rotational speed of the device for relaxing muscles in the massage process of the device for relaxing muscles;
Comparing the current rotational speed with the target rotational speed, and adjusting the current rotational speed to the target rotational speed according to a comparison result;
Specifically, a specific calculation process of the current rotational speed current_speed is as follows:

$$current\_speed = ( ( {m}_{n}^{i} - {m}_{1}^{i} ) / M ) / ( ( n - 1 ) \cdot Vt ) ;$$

where n is a number of times that a number of pulses of the rotating wheel set is read,

$${m}_{1}^{i} and {m}_{n}^{i}$$

are respectively numbers of pulses of the rotating wheel set read at a first time and an n^{th} time in an i^{th} round of reading, M is a corresponding number of pulses of the rotating wheel set when the massage part rotates one circle, and Vt is a preset time.

Optionally, the step of adjusting the current rotational speed to the target rotational speed comprises: Using incremental PID to calculate an adjustment amount Vu(k) of the device for relaxing muscles from the current rotational speed to the target rotational speed, which is specifically as follows:

$$\begin{matrix}Vu ( k ) = u ( k ) - u ( k - 1 ) \\ = {K}_{p} [ e ( k ) - e ( k - 1 ) ] + {K}_{I} e ( k ) + {K}_{D} [ e ( k ) - 2 e ( k - 1 ) + e ( k - 2 ) ]\end{matrix} ;$$

where u(k) is an output of a k^{th} control cycle, u(k−1) is an output of a (k−1)^{th} control cycle, Kₚ is a proportional parameter, Kᵣ is an integral parameter, K_{D} is a differential parameter, k is a number of control cycles, e(k) is an error between the current rotational speed and the target rotational speed in the k^{th} control cycle, e(k−1) is an error between the current rotational speed and the target rotational speed in the (k−1)^{th} control cycle, and e(k−2) is an error between the current rotational speed and the target rotational speed in a (k−2)^{th} control cycle.

In still another aspect, the present application provides a sliding control method which is applied to the device for relaxing muscles by automatically rolling and pressing muscles in any one of the above items, and characterized in that the device for relaxing muscles comprises an actuating mechanism, a rotating wheel set and a driving mechanism; the rotating wheel set comprises a first wheel set and a second wheel set, the first wheel set and the second wheel set are respectively arranged at both ends of the actuating mechanism, the driving mechanism is arranged between the first wheel set and the actuating mechanism, and the driving mechanism is connected to the first wheel set and the actuating mechanism; and the rotating wheel set is provided with position sensors;

The sliding control method comprises the following steps:
Acquiring a massage area of a user;
Acquiring a current position of the rotating wheel set according to a total number of triggers of the position sensors;
Controlling the driving motor to rotate based on the massage area and the current position.

Optionally, the step of controlling the driving motor to rotate based on the massage area and the current position is specifically as follows:
Judging whether the current position is equal to the ending position of the massage area;
If yes, updating the current position of the rotating wheel set to the ending position, and controlling the driving motor to rotate reversely, so as to drive the actuating mechanism and the rotating wheel set to move in an opposite direction, or controlling the driving motor to stop massaging;
If not, controlling the driving motor to continue rotating, so as to drive the actuating mechanism and the rotating wheel set to continue moving.

Optionally, the current position L′=L″+N, where L″ is the starting position of the rotating wheel set, and N is the total number of triggers of the position sensors on the rotating wheel set.

The total number of triggers N=N_{down}+Nᵤₚ, where N_{down} is a number of falling edge triggers of the position sensors, and Nᵤₚ is a number of rising edge triggers of the position sensors.

Optionally, N_{down} is obtained through the following process:
Collecting a falling edge trigger of the position sensors and a rotation direction of the driving motor;
When the falling edge trigger of the position sensors occurs and the rotation direction of the driving motor is forward, increasing the number of falling edge triggers by 0.5;
When the falling edge trigger of the position sensors occurs and the rotation direction of the driving motor is backward, decreasing the number of falling edge triggers by 0.5.

Optionally, a plurality of position sensors are provided, and the plurality of position sensors are uniformly arranged around an axis of the rotating wheel set;

Nᵤₚ is obtained through the following process:
Collecting a rising edge trigger and a trigger time sequence of the plurality of position sensors;
When the rising edge trigger of the position sensors occurs and the trigger time sequence of the plurality of position sensors is clockwise, increasing the number of rising edge triggers by 1;
When the rising edge trigger of the position sensors occurs and the trigger time sequence of the plurality of position sensors is anticlockwise, decreasing the number of rising edge triggers by 1.

Optionally, the number of the position sensors is n or 2n, wherein n≥3; When the number is 2n, a sensor group is formed by two position sensors symmetrical about the axis of the rotating wheel set.

Compared with the prior art and traditional foam rollers, the device for relaxing muscles by automatically rolling and pressing muscles of the present invention provides automated operation, reducing a user's learning effort, physical exertion, and difficulty of use. The present invention enables efficient and deep relaxation of muscles throughout the body for the user in both lying and prone positions, allowing the user to rest or use a mobile phone in a relaxation process. As the muscles and other tissues of the user are more relaxed during use of the present invention, a relaxation effect is indirectly enhanced. In the present invention, two wheel set modules on both sides are synchronized in a mechanical structure, which simplifies control difficulty and improves stability of a product.

In the present invention, a massage area of a user is acquired for each user, thus to control the device for relaxing muscles to perform massage on the massage area, which can fully cover the massage area specified by the user without exceeding the massage area specified, so that a massage effect is better. In addition, the current position of the rotating wheel set is acquired according to the position sensors, and the driving motor is controlled to rotate in combination with the massage area of the user, thus to drive the actuating mechanism and the rotating wheel set to move and complete the massage, and ensure that the device for relaxing muscles can move from the starting position to the ending position of the massage area without any deviation in a massage distance due to issues such as sliding, so that the massage effect and user experience are improved.

### DESCRIPTION OF THE DRAWINGS

To more clearly describe the technical solution in the embodiments of the present application, the drawings needed to be used in the embodiments of the present application are described below.

FIG. 1 is a structural schematic diagram of a device for relaxing muscles by automatically rolling and pressing muscles provided in an embodiment of the present invention;

FIG. 2 is a structural schematic diagram of a driving mechanism in a device for relaxing muscles by automatically rolling and pressing muscles provided in an embodiment of the present invention;

FIG. 3 is a schematic diagram of connection among a driving mechanism, a first wheel set and an actuating mechanism in a device for relaxing muscles by automatically rolling and pressing muscles provided in an embodiment of the present invention;

FIG. 4 is an exploded diagram of a device for relaxing muscles;

FIG. 5 is an amplified view of area A in FIG. 4;

FIG. 6 is a structural diagram of a planetary gear set;

FIG. 7 is a flow chart of a control method of a device for relaxing muscles provided by the present invention;

FIG. 8 is a flow chart of controlling a driving motor to rotate according to a number of rotations;

FIG. 9 is an overall flow chart of a sliding control method provided by the present invention;

FIG. 10 is a detailed flow chart of a sliding control method provided by the present invention;

FIG. 11 is a schematic diagram of Hall sensors and a magnet.

In the figures:

1. supporting shaft; 10. actuating mechanism; 11. connecting shaft; 20. first wheel set; 21. second wheel set; 30. decelerator; 31. connecting piece; 32. driving motor; 33. output shaft; 40. planetary gear set; 41. sun gear; 42. planet gear; 43. planet carrier; 44. ring gear; 50. first chassis; 51. driving wheel; 52. rack; 60. second chassis; 70. Hall sensor; 80. magnet; 90. massage part.

### DETAILED DESCRIPTION OF THE INVENTION

To make the purpose, the technical solution and the advantages of the present invention more clear, the present invention will be further described below in detail in combination with the drawings and the embodiments. It should be understood that the specific embodiments described herein are only used for explaining the present invention, not used for limiting the present invention.

Terms such as “first” and “second” in the embodiments of the present invention are only used for distinguishing relevant technical features and do not indicate a sequence. It shall be understood that such data may be exchanged under appropriate circumstances so as to describe the embodiments of the present application.

Moreover, terms of “comprise” and “have” as well as any other variant are intended to cover non-exclusive inclusion, for example, processes, methods, systems, products or devices including a series of steps or units are not limited to those steps or units clearly listed, but include other steps or units that are not listed clearly or are inherent to these processes, methods, products or devices.

In the present application, terms such as “upper”, “lower”, “inner”, “middle”, “outer”, “front” and “rear” indicate direction or position relationships shown based on the drawings. These terms are mainly intended to better describe the present application and embodiments and not intended to limit that the devices, elements or components indicated must have a specific direction or must be constructed and operated in a specific direction.

Moreover, part of the above terms may be used for indicating other meanings in addition to the direction or position relationships. For example, the term “up” may also be used for indicating a dependency relationship or connection relationship in some cases. For those ordinary skilled in the art, the specific meanings of these terms in the present application may be understood according to concrete conditions.

In addition, terms such as “assembly”, “arrange”, “connect” and “fix” shall be understood in a broad sense. For example, “connect” may refer to fixed connection, detachable connection or an integral structure; may refer to mechanical connection or electrical connection; and may refer to direct connection or indirect connection through an intermediate medium or inner communication of two devices, elements or components.

To make the purpose, the technical solution and the advantages of the present invention more clear, the present invention will be further described below in detail in combination with the drawings and the embodiments. It should be understood that the specific embodiments described herein are only used for explaining the present invention, not used for limiting the present invention.

The present invention aims to help a user achieve deep relaxation of most muscles throughout the body in a time-saving and labor-saving manner in both lying and prone positions, and enable the user to take a rest or use a cell phone in a relaxation process. The present invention solves the problem that the user needs to exert a force by his/her own muscles and keep attention to complete the relaxation of most muscles throughout the body.

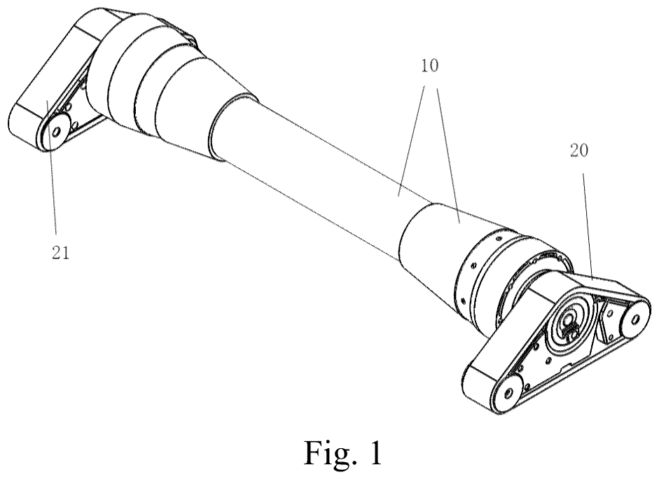

A device for relaxing muscles by automatically rolling and pressing muscles provided by an embodiment of the present invention, as shown in FIG. 1 to FIG. 3, comprises an actuating mechanism 10, a first wheel set 20, a second wheel set 21 and a driving mechanism; the first wheel set 20 and the second wheel set 21 are respectively arranged at both ends of the actuating mechanism 10, the driving mechanism is arranged between the first wheel set 20 and the actuating mechanism 10, and the driving mechanism is connected to the first wheel set 20 and the actuating mechanism 10; The driving mechanism is connected to the first wheel set 20 and the second wheel set 21 on both sides as well as a main body of the actuating mechanism 10, and is used for driving the actuating mechanism 10 to roll automatically.

More specifically, it may be that the driving mechanism comprises a decelerator 30, a connecting piece 31 and a driving motor 32. In this way, the driving motor 32, a connecting shaft 11, the decelerator 30, and the first wheel set 20 and the second wheel set 21 on both sides are connected as a whole.

Here, a single driving motor 32 connected to the connecting shaft 11 can be used for driving, or two driving motors 32 distributed on both sides or more than two driving motors 32 can be used for driving.

More specifically, it may be that the driving mechanism further comprises the connecting shaft 11, and the connecting shaft 11 is used for connecting the first wheel set 20 and the second wheel set 21.

More specifically, it may be that the device for relaxing muscles by automatically rolling and pressing muscles further comprises a circuit module, and the circuit module is arranged in a cavity of the actuating mechanism 10 together with a motor stator and the connecting shaft 11.

More specifically, it may be that the decelerator 30 is connected to the first wheel set 20. Since the first wheel set 20 and the second wheel set 21 on both sides are preferred to be driven by power sources with a same rotational speed and torque, the first wheel set 20 and the second wheel set 21 on both sides are connected by the connecting shaft 11, and the connecting shaft 11 here can be driven by one or more driving motors 32.

The actuating mechanism 10 is rotatably sheathed outside the connecting shaft 11, and more specifically, it may be that a bearing is arranged between the actuating mechanism 10 and the connecting shaft.

More specifically, it may be that the circuit module is arranged in the actuating mechanism 10.

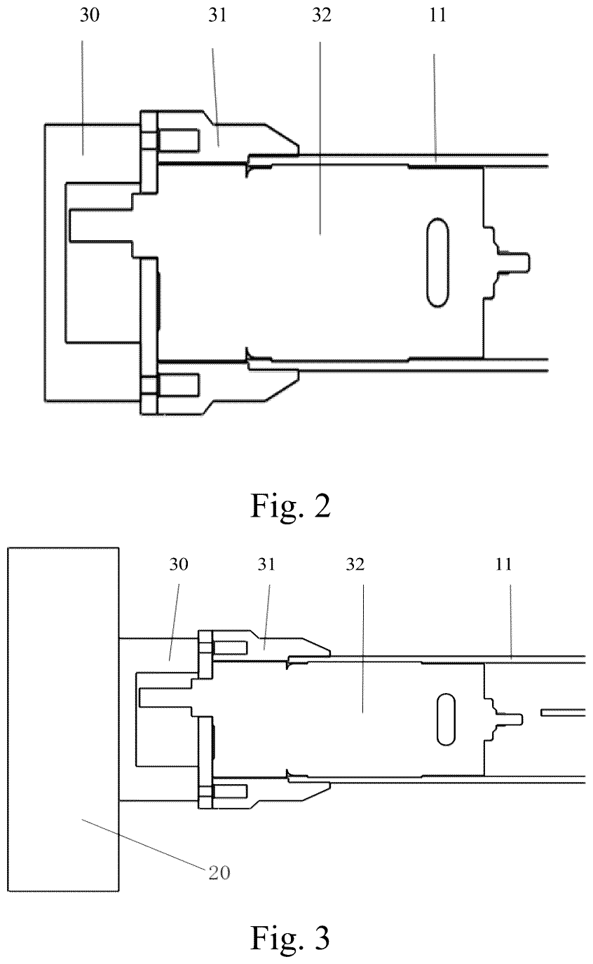

Specifically, as shown in FIG. 2 and FIG. 3, an input end of the decelerator 30 is connected to an output shaft of the driving motor 32, and an output end of the decelerator 30 is connected to the actuating mechanism 10.

More specifically, it may be that the first wheel set 20 and the second wheel set 21 are either roller wheel sets or track wheel sets. More specifically, the first wheel set 20 and the second wheel set 21 are concentric wheels. If the first wheel set 20 and the second wheel set 21 are roller wheel sets, the wheel sets can be concentric wheels; if the first wheel set 20 and the second wheel set 21 are track wheel sets, each wheel set can be composed of a middle supporting piece and a track, the tracks are driven by concentric wheels, and the tracks rotate around the middle supporting pieces.

The first wheel set 20 and the second wheel set 21 can also be used in conjunction with a bracket to move on the bracket. At the same time, the first wheel set 20 and the second wheel set 21 do not necessarily have to move, the first wheel set 20 and the second wheel set 21 can be fixed in one position, with only the actuating mechanism 10 rotating independently.

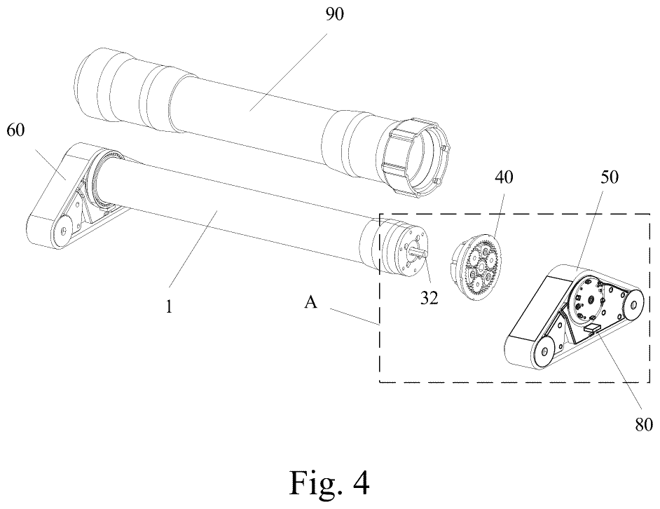

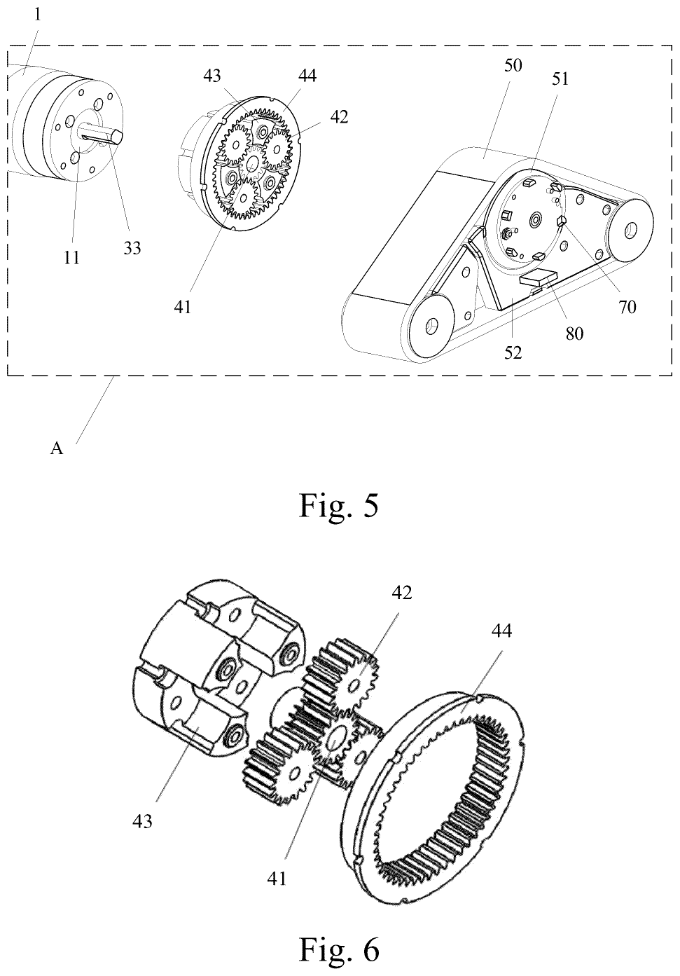

Specifically, as shown in FIG. 4, the device for relaxing muscles comprises a supporting shaft 1, the motor 32, a planetary gear set 40, a massage part 90, a first chassis 50, a second chassis 60 and a control module; as shown in FIG. 4, one end of the supporting shaft 1 is connected to the second chassis 60, the other end of the supporting shaft 1 is fixedly provided with the motor 32, the motor 32 is further connected to the control module by signals, and the planetary gear set 40 and the first chassis 50 are arranged in sequence on one side of the motor 32 away from the supporting shaft 1; as shown in FIG. 5 and FIG. 6, a sun gear 41 in the planetary gear set 40 is connected to an output shaft 33 of the motor 32, a planet carrier 43 is connected to a driving wheel 51 of the first chassis 50, planet gears 42 are meshed with the sun gear 41 and a ring gear 44, and the ring gear 44 is further connected to the massage part 90 sheathed outside the supporting shaft 1.

The first chassis 50 is a track chassis and further comprises a rack 52, a driven wheel and a track, both the driving wheel 51 and the driven wheel are rotatably arranged on the rack 52, the driving wheel 51 is connected to the driven wheel through the track, Hall sensors 70 are arranged on an edge of the driving wheel 51, and a magnet 80 is arranged on the rack 52 at a position near the driving wheel 51.

When the device for relaxing muscles is used, the motor 32 is started, the sun gear 41 of the planetary gear set 40 is driven by the output shaft 33 of the motor 32 to rotate; on one hand, the massage part 90 is driven by sun gear 41 through the planet gears 42 and the ring gear 44 to rotate around an axis thereof, and a massage area is massaged by an outer side of the massage part 90; on the other hand, the driving wheel 51 is driven by the planet carrier 43 to rotate, and then the driven wheel is driven by the driving wheel 51 to rotate and make the first chassis 50 drive the massage part 90 to move in the massage area, thus to achieve all-round massage.

When the Hall sensors 70 are driven by the driving wheel 51 to rotate, a level jump will be produced and a pulse signal will be sent out whether the Hall sensors 70 approach or move away from the magnet 80, and a number of pulses of a rising edge or a falling edge can be counted to obtain a number of pulses corresponding to a number of rotations of the driving wheel 51.

When encoders are used as position sensors, a number of pulses recorded by the encoders when the driving wheel 51 rotates can be read directly.

The device for relaxing muscles provided by the present embodiment comprises the driving motor as well as the actuating mechanism and a rotating wheel set connected to the driving motor, wherein the actuating mechanism and the rotating wheel set are simultaneously driven by the driving motor to move, and the actuating mechanism is configured to: acquire a massage area of a user; obtain a number of rotations that the rotating wheel set should make according to the massage area; and control the driving motor to rotate according to the number of rotations.

In some embodiments of the present invention, the driving motor 32 is connected to the actuating mechanism 10 and the rotating wheel set through the planetary gear set 40, and the rotating wheel set is provided with the position sensors which are used for detecting the number of rotations of the rotating wheel set.

The position sensors can be Hall sensors, optical flow sensors, gyroscopes, encoders, etc., and the encoders can be mechanical encoders, photoelectric encoders, inductive encoders or magnetic encoders.

Considering that in control of an existing massage device, a fixed moving distance is generally and simply set when the device leaves a factory, allowing the massage device to move back and forth for massage within the distance. However, due to different physical conditions and heights of users, as well as varying proportions of different body parts in heights of men and women, an existing control method may result in a massage distance not fully covering the massage area specified by the user or exceeding the massage area specified by the user, leading to a poor massage effect.

In view of this, in another aspect, the present application provides a control method which is applied to the device for relaxing muscles by automatically rolling and pressing muscles in any one of the above items, wherein the control method comprises:
S1: Acquiring a massage area of a user;
S2: Obtaining a number of rotations that the rotating wheel set should make according to the massage area;
S3: Controlling the driving motor to rotate according to the number of rotations.

Specifically, an existing device for relaxing muscles can basically meet usage needs of users of various body shapes, and a width of the massage part 90 is fixed and cannot be adjusted. Therefore, when obtaining the massage area of the user, the width of the massage area does not need to be considered, and only a length of the massage area, i.e., a forward distance of the massage part 90, needs to be considered.

In an automatic mode, the step of acquiring a massage area of a user is specifically as follows: determining the length L of the massage area, wherein L is set by the user according to his/her own massage need, or determined according to a height of the user and a proportion coefficient of the massage area to the height of the user, and calculated by the control module. L=H·l, where L is in cm, H is the height of the user, which is also in cm, and/is the proportion coefficient of the massage area to the height of the user; when a gender of the user is changed, the proportion coefficient is also changed accordingly.

The massage area is a thigh, a shank, a buttock, a waist, an upper back, a forearm, an upper arm, etc. of the user. When the user is a male with a height of 180 cm and the massage area is the shank, as the length of the shank of an adult male is approximately 0.21 times the height, the length of the massage area on the shank of the user is 0.21*180 cm=37.8 cm.

The step of obtaining a number of rotations that the rotating wheel set should make according to the massage area is specifically as follows:
Acquiring the height and the gender of the user, calculating the massage area for each part of a body based on the height and the gender, and converting the massage area into the number of rotations.

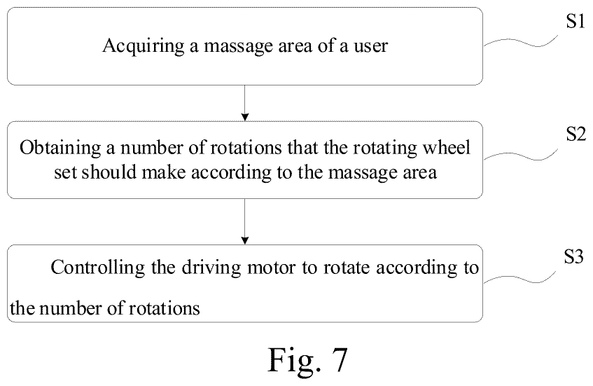

As shown in FIG. 7, in some embodiments of the present invention, the step of controlling the driving motor to rotate according to the number of rotations is specifically as follows:
Starting the driving motor;
Reading an actual number of pulses N′ of the position sensors on the rotating wheel set in real time;
Judging whether the actual number of pulses N′ is equal to a number of pulses corresponding to the number of rotations that the rotating wheel set should make;
If yes, resetting the number of pulses of the position sensors to zero, and controlling the driving motor to rotate reversely, so as to drive the rotating wheel set to move in an opposite direction or stop moving;
If not, controlling the driving motor to continue rotating without changing direction, so as to drive the rotating wheel set to continue moving.

After changing direction of the device for relaxing muscles, repeatedly collecting the actual number of pulses of the position sensors on the rotating wheel set, comparing the actual number of pulses with the number of pulses corresponding to the number of rotations that the rotating wheel set should make, and controlling a moving direction of the device for relaxing muscles to achieve repeated massage.

Specifically, the number of pulses corresponding to the number of rotations that the rotating wheel set should make is a number of pulses corresponding to the number of rotations of the rotating wheel set when the device for relaxing muscles moves from a starting position to an ending position of the massage area; The actual number of pulses N′ is a number of pulses of the position sensors on the rotating wheel set in a massage process of the device for relaxing muscles.

The number of pulses N corresponding to the number of rotations is calculated as follows:

$$N = ( L / π d ) \cdot z \cdot δ ;$$

where L is the length of the massage area, which is in cm, d is a diameter of the massage part 90 in the device for relaxing muscles, which is in cm, Z is a transmission ratio of the planet carrier 43 to the sun gear 41 in the planetary gear set 40, and δ is a pulse equivalent of the driving motor.

In the present embodiment, before massage, the number of pulses N corresponding to the number of rotations that the driving wheel 51 should make when the massage part 90 in the device for relaxing muscles moves from the starting position to the ending position of the massage area is calculated according to the length of the massage area. During massage, the massage part 90 of the device for relaxing muscles is first placed at the starting position of the massage area, the motor 32 is started, the actual number of pulses N′ of the Hall sensors 70 on the driving wheel 51 is read in real time, and whether N′ is equal to N is judged; if N′ is equal to N, it indicates that the device for relaxing muscles has reached the ending position of the massage area; at this time, the number of pulses of the Hall sensors 70 is reset to zero by the control module, the motor 32 is driven to rotate in the opposite direction, and the massage part 90 is driven by the driving wheel 51 to continue massaging in the opposite direction or stop massaging; if N′ is less than N, it indicates that the device for relaxing muscles has not yet moved to the ending position of the massage area; at this time, the motor 32 is controlled by the control module to drive the driving wheel 51 and the massage part 90 to continue massaging in the same direction until the device reaches the ending position.

In the present invention, corresponding lengths of different massage areas of the user are calculated for each user, and then the length of each massage area is converted into the number of pulses corresponding to the number of rotations that the rotating wheel set in the device for relaxing muscles should make, thus to control the device for relaxing muscles to perform massage on the massage area, which can fully cover the massage area specified by the user without leaving any part unmassaged or exceeding the massage area, so that the massage effect and user experience are improved.

In some embodiments of the present invention, the above control method further comprises setting a target rotational speed of the device for relaxing muscles, and controlling a current rotational speed of the device for relaxing muscles according to the target rotational speed, which is specifically as follows: Collecting the current rotational speed of the device for relaxing muscles in the massage process of the device for relaxing muscles, comparing the current rotational speed with the target rotational speed, and adjusting the current rotational speed to the target rotational speed according to a comparison result.

A setting range of the target rotational speed is 30 rpm-90 rpm.

In the present embodiment, the target rotational speed of the driving wheel 51 in the device for relaxing muscles is set according to a massage experience effect of the user, the current rotational speed of the driving wheel 51 is collected at a preset time interval, and the current rotational speed of the driving wheel 51 is compared with the target rotational speed; if the current rotational speed is consistent with the target rotational speed, no processing is needed; if an error exist between the current rotational speed and the target rotational speed, the current rotational speed of the driving wheel 51 is adjusted to the target rotational speed.

In some embodiments of the present invention, incremental PID is used to adjust the current rotational speed of the driving wheel 51 to the target rotational speed.

A calculation formula of incremental PID is as follows:

$$\begin{matrix}Vu ( k ) = u ( k ) - u ( k - 1 ) \\ = {K}_{p} [ e ( k ) - e ( k - 1 ) ] + {K}_{I} e ( k ) + {K}_{D} [ e ( k ) - 2 e ( k - 1 ) + e ( k - 2 ) ]\end{matrix} ;$$

where vu(k) is an adjustment amount of the device for relaxing muscles from the current rotational speed to the target rotational speed, u(k) is an output of a k^{th} control cycle, u (k−1) is an output of a (k−1)^{th} control cycle, Kₚ is a proportional parameter, K_{I} is an integral parameter, K_{D} is a differential parameter, k is a number of control cycles, e (k) is an error between the current rotational speed and the target rotational speed in the k^{th} control cycle, e (k−1) is an error between the current rotational speed and the target rotational speed in the (k−1)^{th} control cycle, and e(k−2) is an error between the current rotational speed and the target rotational speed in a (k−2)^{th} control cycle.

In the present embodiment, it is assumed that the current rotational speed of the driving wheel 51 is current_speed, the target rotational speed is target_speed, e(k) is current_error=current_speed−target_speed, e(k−1) is last_error, e(k−2) is llast_error, vu(k) is output, and all values are initialized to 0, then

$$output = {K}_{p} ( current\_erro - last\_error ) + {K}_{I} \cdot current\_error + {K}_{D} ( current\_error - 2 \cdot last\_error + llast\_error )$$

Updating is Carried Out after Each Adjustment

llast_error=last_error last_error=current_error, and then the current rotational speed of the driving wheel 51 is adjusted to the target rotational speed through incremental PID on this basis.

In some embodiments of the present invention, the number of pulses of the Hall sensors 70 on the driving wheel 51 is read at a preset time interval in the massage process of the device for relaxing muscles; and after reading for n times, an array

$$\{ {m}_{1}^{i} , {m}_{2}^{i} , {m}_{3}^{i} , L , {m}_{n}^{i} \}$$

is formed. The array is updated after the preset time interval, and a new array is

$$\{ {m}_{2}^{i + 1} , {m}_{3}^{i + 1} , {m}_{4}^{i + 1} , L , {m}_{n + 1}^{i + 1} \} ,$$

where n is a number of times that the number of pulses of the Hall sensors 70 is read, n≤6, i is a number of rounds that the number of pulses of the Hall sensors 70 is read,

$${m}_{1}^{i} , {m}_{2}^{i} , {m}_{3}^{i}$$

and mₙⁱ are respectively numbers of pulses of the Hall sensors 70 read at a first time, a second time, a third time and an n^{th} time in an i^{th} round of reading, and

$${m}_{2}^{i + 1} , {m}_{3}^{i + 1} , {m}_{4}^{i + 1} and {m}_{n + 1}^{j + 1}$$

are respectively number of pulses of the Hall sensors 70 read at a first time, a second time, a third time and an n^{th} time in an (i+1)^{th} round of reading.

The current rotational speed current_speed of the Hall sensors 70 is calculated according to the numbers of pulses read, and

$$c urrent\_speed = ( ( {m}_{n}^{i} - {m}_{1}^{i} ) / M ) / ( ( n - 1 ) \cdot Vt ) ,$$

$$where {m}_{1}^{i} and {m}_{n}^{i}$$

and respectively the numbers of pulses of the Hall sensors 70 read at the first time and the n^{th} time in the i^{th} round of reading, M is a corresponding number of pulses of the Hall sensors 70 when the massage part 90 rotates one circle, Vt is the preset time interval, i.e., a time interval between two readings of the number of pulses, and Vt≤10 ms.

Specifically, it is assumed that the corresponding number of pulses of the Hall sensors 70 when the massage part 90 or the ring gear 44 rotates one full circle is 1000, the preset time interval Vt is 10 ms, n=6, the array is read again at a time interval of 10 ms, the numbers of pulses of the Hall sensors 70 read in the first round are

$$\{ {m}_{1}^{1} , {m}_{2}^{1} , {m}_{3}^{1} , L , {m}_{6}^{1} \} = \{ 5 , 10 , 15 , 20 , 25 , 30 \} ,$$

the numbers of pulses of the Hall sensors 70 read after the time interval of 10 ms are

$$\{ {m}_{2}^{2} , {m}_{3}^{2} , {m}_{4}^{2} , L , {m}_{7}^{2} \} = \{ 10 , 15 , 20 , 25 , 30 , 35 \} ,$$

and so on.

Then the current rotational speed of the driving wheel 51 at the 60^{th} ms is current_speed=((35−10)/1000)/((6−1)·10) 0.5×10⁻³ rpms=30 rpm.

In the present embodiment, when the device for relaxing muscles operates in a manual mode, a specific process of determining the number of pulses corresponding to the number of rotations that the rotating wheel set should make, i.e., the number of pulses corresponding to the number of rotations of the driving wheel 51, based on the length of the massage area is as follows:

Before massage, the length of the massage area is visually estimated or perceived by the user, the massage part 90 of the device for relaxing muscles is placed at the starting position of the massage area, the number of pulses of the Hall sensors 70 on the driving wheel 51 is reset to zero, then the motor 32 is started, and the massage part 90 is driven by the motor 32 to move in the massage area; when the device reaches the ending position of the massage area, the number of pulses N corresponding to the number of rotations of the driving wheel 51 is read.

During massage, the actual number of pulses of the Hall sensors 70 on the driving wheel 51 is read in real time and compared with the number of pulses N corresponding to the number of rotations of the driving wheel 51, thus to adjust a rotation direction of the motor 32 and a moving direction of the massage part 90.

In some embodiments of the present invention, during massage in the manual mode, the user can also set the target rotational speed of the driving wheel 51 to 30 rpm-90 rpm according to his/her own massage experience, read the current rotational speed of the driving wheel 51 at the preset time interval, and manually adjust the current rotational speed of the driving wheel 51 to the target rotational speed.

An existing rolling massage device, when used, is driven by human pressure to perform massage. However, due to the facts that the user exerts a relatively low pressure, material of clothes is relatively smooth, the clothes are too loose, etc., the rolling massage device is prone to spinning in situ. If only a number of pulses of encoders in a motor is used to calculate a massage distance, a large error will be produced, causing misalignment and resulting in a poor massage effect.

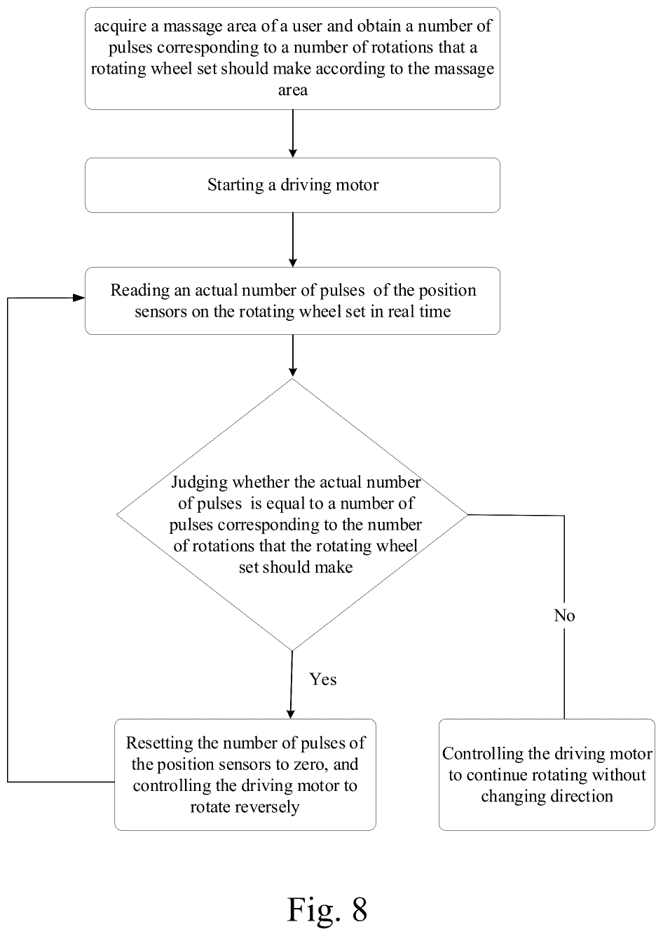

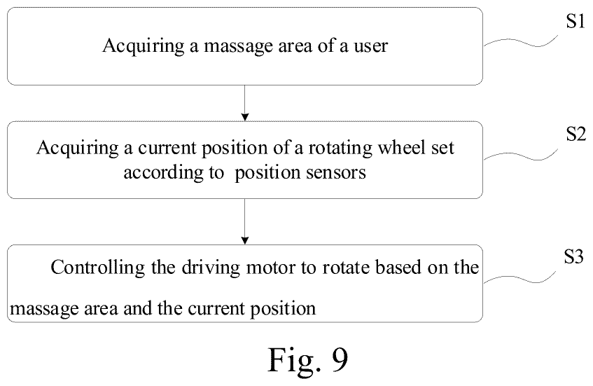

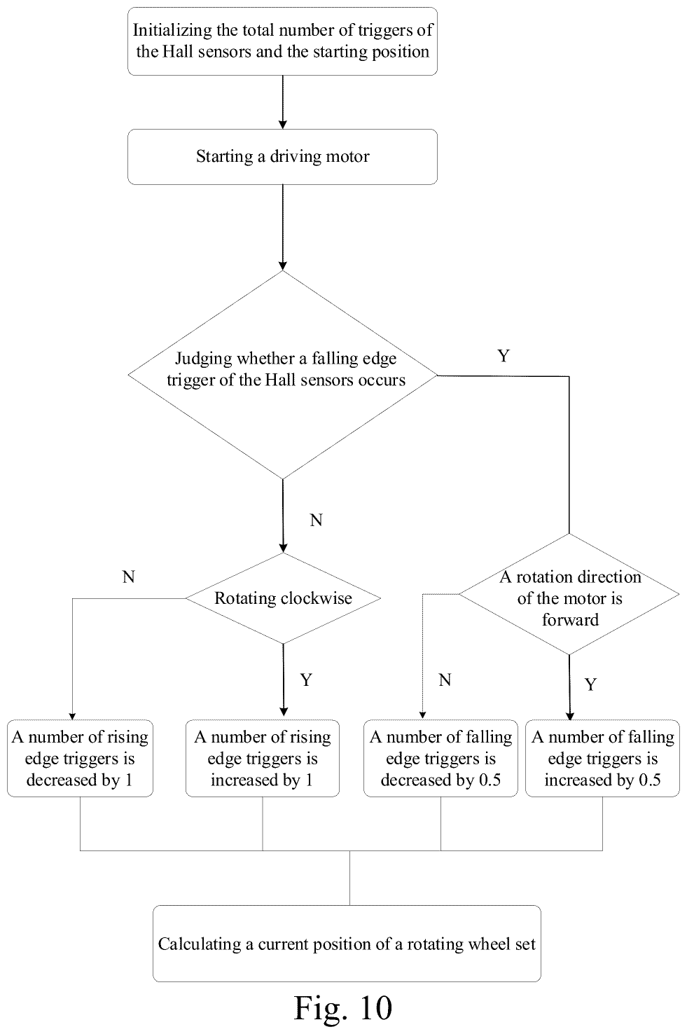

The present embodiment further provides a sliding control method which is applied to the above device for relaxing muscles, as shown in FIG. 8 to FIG. 10, and comprises the following steps:

S1: Acquiring a massage area of a user;
Determining the length of the massage area, i.e., the starting position and the ending position where the device for relaxing muscles should be moved, according to the height of the user and a proportion coefficient of the massage area to the height of the user, or setting the length of the massage area according to the massage need of the user. Specifically, the massage area is a thigh, a shank, a buttock, a waist, an upper back, a forearm, an upper arm, etc. of the user. When the user is a male with a height of 180 cm and the massage area is the shank, as the length of the shank of an adult male is approximately 0.21 times the height, a moving distance of the device for relaxing muscles when massage is performed on the shank of the user is 0.21*180 cm=37.8 cm.

S2: Acquiring a current position of the rotating wheel set according to a total number of triggers of the position sensors;
Initializing the total number of triggers of the Hall sensors 70 and the starting position;
Starting the driving motor 32, and reading the rotation direction of the motor 32 in real time, thus to calculate a number of falling edge triggers N_{down} of the Hall sensors 70; and counting a number of times that the Hall sensors 70 approach the magnet 80 and a trigger time sequence of the plurality of Hall sensors 70 to obtain a number of rising edge triggers Nᵤₚ of the Hall sensors 70, thus to obtain the total number of triggers N=N_{down}+Nᵤₚ of the Hall sensors 70, i.e., the total number of triggers N of rotation of the driving wheel 51;
Calculating a current position L′=L″+N of the driving wheel 51 according to N, where L″ is a starting position of the driving wheel 51;
Judging whether the current position L′ is equal to the ending position of the massage area;
If equal, it indicates that the massage part 90 of the device for relaxing muscles has been driven by the driving wheel 51 to move from the starting position to the ending position of the massage area; at this time, the starting position of the driving wheel 51 is updated to the ending position of the massage area, the total number of triggers of the Hall sensors 70 is initialized, and the starting position of the massage area is taken as the ending position to control the motor 32 to continue massaging reversely or stop massaging;
If less, it indicates that the massage part 90 of the device for relaxing muscles has not yet been driven by the driving wheel 51 to move from the starting position to the ending position of the massage area; at this time, the motor 32 is controlled to continue rotating in the same direction until the current position L′ of the driving wheel 51 is equal to the ending position of the massage area.

S3: Controlling the driving motor to rotate based on the massage area and the current position.

In the present invention, the current position of the rotating wheel set is acquired through the position sensors, and the driving motor is controlled to rotate in combination with the massage area of the user, thus to drive the actuating mechanism and the rotating wheel set to move and complete the massage, and ensure that the device for relaxing muscles can move from the starting position to the ending position of the massage area without any deviation in a massage distance due to issues such as sliding, so that the massage effect and the user experience are improved.

In some embodiments of the present invention, the step of acquiring a current position of the rotating wheel set is specifically as follows: acquiring the total number of triggers N of the position sensors on the rotating wheel set, and converting the total number of triggers into the current position of the rotating wheel set. In the present embodiment, the rotating wheel set is the first chassis 50, and the position sensors are the Hall sensors 70.

In some embodiments of the present invention, the step of controlling the driving motor to rotate based on the massage area and the current position is specifically as follows: Judging whether the current position is equal to the ending position of the massage area; If yes, updating the current position of the rotating wheel set to the ending position, and controlling the motor to rotate reversely, so as to drive the actuating mechanism and the rotating wheel set to move in an opposite direction, or controlling the driving motor to stop massaging; If not, controlling the motor to continue rotating, so as to drive the actuating mechanism and the rotating wheel set to continue moving.

In the present embodiment, the current position of the rotating wheel set is detected in real time and compared with the ending position of the massage area to judge whether the massage part 90 is driven by the rotating wheel set to move to the ending position of the massage area; in this way, even if the device for relaxing muscles slides in situ during massage, no deviation in the massage distance will occur, which can provide full massage to the massage area, and ensure the massage effect and the user experience.

In some embodiments of the present invention, the current position of the driving wheel 51 is L′=L″+N, where L″ is the starting position of the driving wheel 51, N is the total number of triggers of the Hall sensors 70 on the driving wheel 51, and L′ and L″ are in cm.

In some embodiments of the present invention, N=N_{down}+Nᵤₚ, where N_{down} is a number of falling edge triggers of the Hall sensors 70 on the driving wheel 51, Nᵤₚ is a number of rising edge triggers of the Hall sensors 70 on the driving wheel 51, and units of N, N_{down} and Nᵤₚ are all “times”.

In some embodiments of the present invention, a plurality of Hall sensors 70 are provided, and the plurality of Hall sensors 70 are uniformly arranged around an axis of the driving wheel 51; Preferably, the number of the Hall sensors 70 is n or 2n, wherein n≥3; when the number is 2n, two Hall sensors 70 symmetrical about the axis of the driving wheel 51 are connected to a gate circuit to form a sensor group, and each sensor group is a phase.

Specifically, if one Hall sensor 70 is provided, when the Hall sensor 70 is driven by the rotation of the driving wheel 51 to approach or move away from the magnet 80, both the rising edge trigger and the falling edge trigger occur on the Hall sensor 70, so that it is impossible to judge a rotation direction of the driving wheel 51 based on this, and thus it is impossible to determine the number of rising edge triggers; if two Hall sensors 70 are provided, when the Hall sensors 70 are driven by the rotation of the driving wheel 51 to approach or move away from the magnet 80, forward and reverse rotations of the driving wheel 51 cause the trigger time sequences of the two Hall sensors 70 to be the same, so that it is also impossible to judge the rotation direction of the driving wheel 51 based on this, and thus it is impossible to determine the number of rising edge triggers.

In the present embodiment, three Hall sensors 70 are provided, and the three Hall sensors 70 are arranged as a first phase, a second phase and a third phase clockwise. When the Hall sensors 70 of the first phase, the third phase and the second phase are driven in sequence by the driving wheel 51 to approach the magnet 80, it indicates that the driving wheel 51 rotates clockwise, and the number of rising edge triggers Nᵤₚ is increased by 1; when the Hall sensors 70 of the first phase, the second phase and the third phase are driven in sequence by the driving wheel 51 to approach the magnet 80, it indicates that the driving wheel 51 rotates anticlockwise, and the number of rising edge triggers Nᵤₚ is decreased by 1.

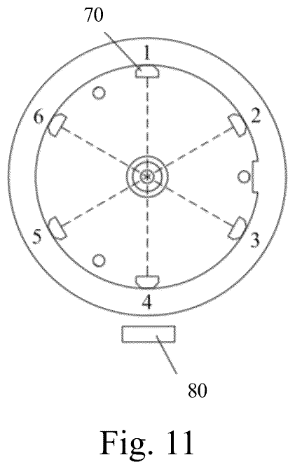

In another embodiment, as shown in FIG. 11, six Hall sensors 70 are provided on the driving wheel 51 and are numbered by 1, 2, 3, 4, 5, 6 in sequence in a clockwise direction, wherein Hall sensor No. 1 and Hall sensor No. 4 are connected to the gate circuit to form the first phase, Hall sensor No. 2 and Hall sensor No. 5 are connected to the gate circuit to form the second phase, and Hall sensor No. 3 and Hall sensor No. 6 are connected to the gate circuit to form the third phase.

Taking a position shown in FIG. 11 as the starting position of the driving wheel 51, when the rising edge trigger occurs on the first phase, the third phase and the second phase in sequence, the planet carrier 43/the driving wheel 51 rotates clockwise, and the number of rising edge triggers Nᵤₚ is increased by 1; when the rising edge trigger occurs on the first phase, the second phase and the third phase in sequence, the planet carrier 43/the driving wheel 51 rotates anticlockwise, and the number of rising edge triggers Nᵤₚ is decreased by 1.

In some embodiments of the present invention, the number of falling edge triggers N_{down} of the Hall sensors 70 on the driving wheel 51 is obtained through the following process:
Collecting a falling edge trigger of the position sensors and a rotation direction of the driving motor;
When the falling edge trigger of the position sensors occurs and the rotation direction of the driving motor is forward, increasing the number of falling edge triggers by 0.5;
When the falling edge trigger of the position sensors occurs and the rotation direction of the driving motor is backward, decreasing the number of falling edge triggers by 0.5.

If the Hall sensors 70 move away from the magnet 80, when the falling edge trigger of the Hall sensors 70 is read by an MCU, as both the clockwise and the anticlockwise rotations of the planet carrier 43/the driving wheel 51 are triggered by the same Hall sensor 70, a trigger phase will not be changed. Therefore, the rotation direction of the motor 32 that drives the driving wheel 51 to rotate in the device for relaxing muscles needs to be introduced. If the falling edge trigger of the position sensors occurs, and the rotation directions of the driving wheel 51 and the motor 32 are forward, the number of falling edge triggers is increased by 0.5; if the falling edge trigger of the position sensors occurs, and the rotation directions of the driving wheel 51 and the motor 32 are backward, the number of falling edge triggers is decreased by 0.5.

The above only describes preferred specific embodiments of the present invention, but the protection scope of the present invention is not limited thereto. Any change or replacement contemplated easily by those skilled in the art familiar with the technical field within the technical scope disclosed by the present invention shall be covered within the protection scope of the present invention. Therefore, the protection scope of the present invention should be determined by the protection scope of the claims.

What is claimed is:

1. A device for relaxing muscles by automatically rolling and pressing muscles, characterized in that the device comprises an actuating mechanism, a rotating wheel set and a driving mechanism;
the rotating wheel set comprises a first wheel set and a second wheel set, the first wheel set and the second wheel set are respectively arranged at both ends of the actuating mechanism, the driving mechanism is arranged between the first wheel set and the actuating mechanism, and the driving mechanism is connected to the first wheel set and the actuating mechanism;
the driving mechanism is used for driving the actuating mechanism to roll automatically;
the driving mechanism comprises a decelerator, a connecting piece and a driving motor.

2. The device for relaxing muscles by automatically rolling and pressing muscles as claimed in claim 1, characterized in that the driving mechanism further comprises a connecting shaft, and the connecting shaft is used for connecting the first wheel set and the second wheel set; and the decelerator is connected to the first wheel set.

3. The device for relaxing muscles by automatically rolling and pressing muscles as claimed in claim 2, characterized in that the actuating mechanism is rotatably sheathed outside the connecting shaft; and a circuit module is arranged in the actuating mechanism.

4. The device for relaxing muscles by automatically rolling and pressing muscles as claimed in claim 3, characterized in that an input end of the decelerator is connected to an output shaft of the driving motor, and an output end of the decelerator is connected to the actuating mechanism.

5. The device for relaxing muscles by automatically rolling and pressing muscles as claimed in claim 1, characterized in that the first wheel set and the second wheel set are either roller wheel sets or track wheel sets.

6. The device for relaxing muscles by automatically rolling and pressing muscles as claimed in claim 1, characterized in that the first wheel set and the second wheel set are concentric wheels.

7. A control method, applied to the device for relaxing muscles by automatically rolling and pressing muscles as claimed in claim 1, wherein the control method specifically comprises the following steps:
acquiring a massage area of a user;
obtaining a number of rotations that the rotating wheel set should make according to the massage area;
controlling the driving motor to rotate according to the number of rotations.

8. The control method as claimed in claim 7, characterized in that the step of obtaining a number of rotations that the rotating wheel set should make according to the massage area is specifically as follows:
acquiring a height and a gender of the user, calculating the massage area for each part of a body based on the height and the gender, or setting the massage area for each part according to a massage need of the user, and converting the massage area into the number of rotations.

9. The control method as claimed in claim 8, characterized in that the driving motor is connected to the rotating wheel set through a planetary gear set, and a number of pulses N corresponding to the number of rotations is:
$$N = ( L / π d ) \cdot z \cdot δ ;$$
where L is a length of the massage area, d is a diameter of a massage part, z is a transmission ratio of a planet carrier to a sun gear in the planetary gear set, and δ is a pulse equivalent of the driving motor.

10. The control method as claimed in claim 9, characterized in that the step of acquiring a massage area of a user is specifically as follows:
setting the length of the massage area according to the massage need of the user;
or determining the length L of the massage area according to the height of the user and a proportion coefficient of the massage area to the height of the user, L=H·l, where H is the height of the user, and l is the proportion coefficient of the massage area to the height of the user.

11. The control method as claimed in claim 10, characterized in that the rotating wheel set is provided with position sensors; and the step of controlling the driving motor to rotate according to the number of rotations is specifically as follows:
starting the driving motor;
reading an actual number of pulses N′ of the position sensors on the rotating wheel set in real time;
judging whether the actual number of pulses N′ is equal to a number of pulses corresponding to the number of rotations that the rotating wheel set should make;
if yes, resetting the number of pulses of the position sensors to zero, and controlling the driving motor to rotate reversely, so as to drive the rotating wheel set to move in an opposite direction or stop moving;
if not, controlling the driving motor to continue rotating without changing direction, so as to drive the rotating wheel set to continue moving.

12. The control method as claimed in claim 11, characterized in that the number of pulses corresponding to the number of rotations that the rotating wheel set should make is a number of pulses corresponding to the number of rotations of the rotating wheel set when the device for relaxing muscles moves from a starting position to an ending position of the massage area;
The actual number of pulses N′ is a number of pulses of the position sensors on the rotating wheel set in a massage process of the device for relaxing muscles.

13. The control method as claimed in claim 7, characterized in that the control method further comprises:
setting a target rotational speed of the device for relaxing muscles;
collecting a current rotational speed of the device for relaxing muscles in the massage process of the device for relaxing muscles;
comparing the current rotational speed with the target rotational speed, and adjusting the current rotational speed to the target rotational speed according to a comparison result;
specifically, a specific calculation process of the current rotational speed current_speed is as follows:
$$current\_speed = ( ( {m}_{n}^{i} - {m}_{1}^{i} ) / M ) / ( ( n - 1 ) \cdot Vt ) ;$$
where n is a number of times that a number of pulses of the rotating wheel set is read, mₗⁱ and mₙⁱ are respectively numbers of pulses of the rotating wheel set read at a first time and an n^{th} time in an i^{th} round of reading, M is a corresponding number of pulses of the rotating wheel set when the massage part rotates one circle, and Vt is a preset time.

14. The control method as claimed in claim 7, characterized in that the step of adjusting the current rotational speed to the target rotational speed comprises:
using incremental PID to calculate an adjustment amount Vu(k) of the device for relaxing muscles from the current rotational speed to the target rotational speed, which is specifically as follows:
$$\begin{matrix}Vu ( k ) = u ( k ) - u ( k - 1 ) \\ = {K}_{p} [ e ( k ) - e ( k - 1 ) ] + {K}_{I} e ( k ) + {K}_{D} [ e ( k ) - 2 e ( k - 1 ) + e ( k - 2 ) ]\end{matrix} ;$$
where u(k) is an output of a k^{th} control cycle, u (k−1) is an output of a (k−1)^{th} control cycle, Kₚ is a proportional parameter, K_{I} is an integral parameter, K_{D} is a differential parameter, k is a number of control cycles, e(k) is an error between the current rotational speed and the target rotational speed in the k^{th} control cycle, e(k−1) is an error between the current rotational speed and the target rotational speed in the (k−1)^{th} control cycle, and e(k−2) is an error between the current rotational speed and the target rotational speed in a (k−2)^{th} control cycle.

15. A sliding control method, applied to the device for relaxing muscles by automatically rolling and pressing muscles as claimed in claim 1, and characterized in that the device for relaxing muscles comprises an actuating mechanism, a rotating wheel set and a driving mechanism; the rotating wheel set comprises a first wheel set and a second wheel set, the first wheel set and the second wheel set are respectively arranged at both ends of the actuating mechanism, the driving mechanism is arranged between the first wheel set and the actuating mechanism, and the driving mechanism is connected to the first wheel set and the actuating mechanism; and the rotating wheel set is provided with position sensors;
the sliding control method comprises the following steps:
acquiring a massage area of a user;
acquiring a current position of the rotating wheel set according to a total number of triggers of the position sensors;
controlling the driving motor to rotate based on the massage area and the current position.

16. The sliding control method as claimed in claim 15, characterized in that the step of controlling the driving motor to rotate based on the massage area and the current position is specifically as follows:
judging whether the current position is equal to the ending position of the massage area;
if yes, updating the current position of the rotating wheel set to the ending position, and controlling the driving motor to rotate reversely, so as to drive the actuating mechanism and the rotating wheel set to move in an opposite direction, or controlling the driving motor to stop massaging;
if not, controlling the driving motor to continue rotating, so as to drive the actuating mechanism and the rotating wheel set to continue moving.

17. The sliding control method as claimed in claim 16, characterized in that the current position L′=L″+N, where L″ is the starting position of the rotating wheel set, and N is the total number of triggers of the position sensors on the rotating wheel set;
the total number of triggers N=N_{down}+Nᵤₚ, where N_{down} is a number of falling edge triggers of the position sensors, and Nᵤₚ is a number of rising edge triggers of the position sensors.

18. The sliding control method as claimed in claim 17, characterized in that N_{down} is obtained through the following process:
collecting a falling edge trigger of the position sensors and a rotation direction of the driving motor;
when the falling edge trigger of the position sensors occurs and the rotation direction of the driving motor is forward, increasing the number of falling edge triggers by 0.5;
when the falling edge trigger of the position sensors occurs and the rotation direction of the driving motor is backward, decreasing the number of falling edge triggers by 0.5.

19. The sliding control method as claimed in claim 17, characterized in that a plurality of position sensors are provided, and the plurality of position sensors are uniformly arranged around an axis of the rotating wheel set;
Nᵤₚ is obtained through the following process:
collecting a rising edge trigger and a trigger time sequence of the plurality of position sensors;
when the rising edge trigger of the position sensors occurs and the trigger time sequence of the plurality of position sensors is clockwise, increasing the number of rising edge triggers by 1;
when the rising edge trigger of the position sensors occurs and the trigger time sequence of the plurality of position sensors is anticlockwise, decreasing the number of rising edge triggers by 1.

20. The sliding control method as claimed in claim 19, characterized in that the number of the position sensors is n or 2n, wherein n≥3;
when the number is 2n, a sensor group is formed by two position sensors symmetrical about the axis of the rotating wheel set.
